(19) United States
(12) Patent Application Publication
(10) Pub. No.: US 2018/0191016 A1
(43) Pub. Date: Jul. 5, 2018

(54) FLOW BATTERIES INCORPORATING A PHENOTHIAZINE COMPOUND WITHIN AN AQUEOUS ELECTROLYTE SOLUTION

(71) Applicant: LOCKHEED MARTIN ADVANCED ENERGY STORAGE, LLC, Bethesda, MD (US)

(72) Inventor: Steven REECE, Cambridge, MA (US)

(21) Appl. No.: 15/399,680

(22) Filed: Jan. 5, 2017

(51) Int. Cl. H01M 8/18; H01M 8/08

(52) U.S. Cl. CPC H01M 8/188; H01M 2300/0002; H01M 8/08

(57) ABSTRACT

Flow batteries can include a first half-cell containing a first aqueous electrolyte solution, a first electrolyte receptacle, a second half-cell containing a second aqueous electrolyte solution, a second electrolyte receptacle, and a separator disposed between the first half-cell and the second half-cell. The first aqueous electrolyte solution contains a first redox-active material and first mobile ions that are each continuously soluble, and the second aqueous electrolyte solution contains a second redox-active material and second mobile ions that are each continuously soluble. At least one of the first redox-active material and the second redox-active material is a phenothiazine compound, a sulfur-oxidized variant thereof, or a salt thereof. The first redox-active material and the first mobile ions circulate between the first half-cell and the first electrolyte receptacle, and the second redox-active material and the second mobile ions circulate between the second half-cell and the second electrolyte receptacle.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD

The present disclosure generally relates to energy storage and, more specifically, to flow batteries and other electrochemical systems containing an organic redox-active material.

### BACKGROUND

Electrochemical energy storage systems, such as batteries, supercapacitors and the like, have been widely proposed for large-scale energy storage applications. Various battery designs, including flow batteries, have been considered for this purpose. Compared to other types of electrochemical energy storage systems, flow batteries can be advantageous, particularly for large-scale applications, due to their ability to decouple the parameters of power density and energy density from one another.

Flow batteries generally include negative and positive active materials in corresponding electrolyte solutions, which are flowed separately across opposing faces of a membrane or separator in an electrochemical cell containing negative and positive electrodes. The terms “membrane” and “separator” are used synonymously herein. The flow battery is charged or discharged through electrochemical reactions of the active materials that occur inside the two half-cells. As used herein, the terms “active material,” “electroactive material,” “redox-active material” or variants thereof synonymously refer to materials that undergo a change in oxidation state during operation of a flow battery or like electrochemical energy storage system (i.e., during charging or discharging).

Although flow batteries hold significant promise for large-scale energy storage applications, they have historically been plagued by sub-optimal energy storage performance (e.g., round trip energy efficiency) and limited cycle life, among other factors. Despite significant investigational efforts, no commercially viable flow battery technologies have yet been developed.

Numerous classes of active materials have been studied in efforts to improve the performance of flow batteries. Both organic active materials and metal-based active materials have been extensively studied.

Organic compounds that are able to undergo a reversible oxidation-reduction cycle can serve as active materials in a flow battery. Organic active materials can be in one or both of the half-cells. Although organic compounds are often capable of transferring more than one electron during an oxidation-reduction cycle, which can be desirable, their use as active materials has historically proven problematic. In particular, many organic compounds offer relatively limited conductivity and energy density values when utilized as active materials. The low energy density values frequently arise due to the relatively low solubility of organic compounds, particularly in aqueous electrolyte solutions. To compensate for their low solubility values, organic compounds are frequently utilized in non-aqueous electrolyte solutions in which they are more soluble. Excessive costs, potential safety issues, and undesired environmental impacts can sometimes accompany the use of organic solvents, particularly in commercial-scale flow battery systems.

Metal-based active materials can similarly undergo a reversible oxidation-reduction cycle when utilized in at least one half-cell of a flow battery. Metal-based active materials can be present in both half-cells of a flow battery, or they can be used in combination with organic active materials in opposing half-cells. Although non-ligated metal ions (e.g., dissolved salts of a redox-active metal) can be used as an active material, it can often be more desirable to utilize coordination compounds for this purpose. As used herein, the terms “coordination complex, “coordination compound,” and “metal-ligand complex” synonymously refer to a compound having at least one covalent bond formed between a metal center and a donor ligand. The donor ligands in a coordination compound can favorably impact solubility as well as tailor the reduction potential of the active material.

Because of their high positive reduction potentials and favorable electrochemical kinetics, iron hexacyanide coordination compounds have historically been a desirable active material for use in the positive half-cell of flow batteries. Although iron hexacyanide coordination compounds are not overly expensive, they still represent one of the more costly components utilized in conventional flow batteries. In addition, the cyanide ligands carried by these coordination compounds can present undesirable environmental, health and safety concerns if not properly managed.

In view of the foregoing, alternative redox-active materials capable of enhancing the performance and safety of flow batteries would be highly desirable in the art. The present disclosure satisfies the foregoing needs and provides related advantages as well.

### SUMMARY

In various embodiments, the present disclosure provides flow batteries including a first half-cell containing a first aqueous electrolyte solution, a first electrolyte receptacle in fluid communication with the first half-cell, a second half-cell containing a second aqueous electrolyte solution, a second electrolyte receptacle in fluid communication with the second half-cell, and a separator disposed between the first half-cell and the second half-cell. The first aqueous electrolyte solution contains a first redox-active material and first mobile ions that are each continuously soluble in the first aqueous electrolyte solution. The second aqueous electrolyte solution contains a second redox-active material and second mobile ions that are each continuously soluble in the second aqueous electrolyte solution. At least one of the first redox-active material and the second redox-active material is a phenothiazine compound, a sulfur-oxidized variant thereof, or a salt thereof. The flow battery is configured to circulate the first redox-active material and the first mobile ions between the first half-cell and the first electrolyte receptacle and the second redox-active material and the second mobile ions between the second half-cell and the second electrolyte receptacle.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 depicts a schematic of an illustrative flow battery.

### DETAILED DESCRIPTION

The present disclosure is directed, in part, to flow batteries incorporating phenothiazine as a redox-active material in an aqueous electrolyte solution. The present disclosure is also directed, in part, to methods for operating flow batteries containing phenothiazine as a redox-active material in an aqueous electrolyte solution.

The present disclosure may be understood more readily by reference to the following description taken in connection with the accompanying figures and examples, all of which form a part of this disclosure. It is to be understood that this disclosure is not limited to the specific products, methods, conditions or parameters described and/or shown herein. Further, the terminology used herein is for purposes of describing particular embodiments by way of example only and is not intended to be limiting unless otherwise specified. Similarly, unless specifically stated otherwise, any description herein directed to a composition is intended to refer to both solid and liquid versions of the composition, including solutions and electrolytes containing the composition, and electrochemical cells, flow batteries, and other energy storage systems containing such solutions and electrolytes. Further, it is to be recognized that where the disclosure herein describes an electrochemical cell, flow battery, or other energy storage system, it is to be appreciated that methods for operating the electrochemical cell, flow battery, or other energy storage system are also implicitly described.

It is also to be appreciated that certain features of the present disclosure may be described herein in the context of separate embodiments for clarity purposes, but may also be provided in combination with one another in a single embodiment. That is, unless obviously incompatible or specifically excluded, each individual embodiment is deemed to be combinable with any other embodiment(s) and the combination is considered to represent another distinct embodiment. Conversely, various features of the present disclosure that are described in the context of a single embodiment for brevity's sake may also be provided separately or in any sub-combination. Finally, while a particular embodiment may be described as part of a series of steps or part of a more general structure, each step or sub-structure may also be considered an independent embodiment in itself

Unless stated otherwise, it is to be understood that each individual element in a list and every combination of individual elements in that list is to be interpreted as a distinct embodiment. For example, a list of embodiments presented as “A, B, or C” is to be interpreted as including the embodiments “A,” “B,” “C,” “A or B,” “A or C,” “B or C,” or “A, B, or C.”

In the present disclosure, the singular forms of the articles “a,” “an,” and “the” also include the corresponding plural references, and reference to a particular numerical value includes at least that particular value, unless the context clearly indicates otherwise. Thus, for example, reference to “a material” is a reference to at least one of such materials and equivalents thereof

In general, use of the term “about” indicates approximations that can vary depending on the desired properties sought to be obtained by the disclosed subject matter and is to be interpreted in a context-dependent manner based on functionality. Accordingly, one having ordinary skill in the art will be able to interpret a degree of variance on a case-by-case basis. In some instances, the number of significant figures used when expressing a particular value may be a representative technique of determining the variance permitted by the term “about.” In other cases, the gradations in a series of values may be used to determine the range of variance permitted by the term “about.” Further, all ranges in the present disclosure are inclusive and combinable, and references to values stated in ranges include every value within that range.

As discussed above, energy storage systems that can be operated on a large scale while maintaining high operating efficiencies and energy densities can be extremely desirable. Flow batteries have generated significant interest in this regard, but there remains room for improving their performance, cost, safety and potential environmental impact. Exemplary description of illustrative flow batteries, their use, and operating characteristics is provided hereinbelow.

The present inventor discovered that certain organic compounds can suitably be used as an active material in aqueous electrolyte solutions. In particular, the inventor discovered that phenothiazine, its oxides and dioxides, and their derivatives can suitably be incorporated in aqueous electrolyte solutions. Aqueous electrolyte solutions containing a phenothiazine compound or a sulfur-oxidized variant thereof can be especially beneficial when incorporated in the positive half-cell of a flow battery, the reasons for which are explained in further detail hereinafter. As used herein, the term “sulfur-oxidized variant thereof” refers to sulfoxide (S═O) and sulfone (O═S═O) variants of a given phenothiazine compound.

One significant advantage of phenothiazine compounds compared to iron hexacyanide coordination compounds, a commonly used active material for the positive half-cell of flow batteries, is that the standard reduction potential of phenothiazine is much more positive. Specifically, phenothiazine has a standard reduction potential of approximately +0.9 V compared to a reversible hydrogen electrode, whereas iron hexacyanide coordination compounds only have a standard reduction potential of approximately +0.45 V compared to a reversible hydrogen electrode. In addition, because phenothiazine and its compounds can transfer two or more electrons per oxidation-reduction cycle (as opposed to one electron for iron hexacyanide coordination compounds), increased energy density values can be realized. Thus, by replacing an iron hexacyanide active material with phenothiazine or a phenothiazine compound, significantly improved safety and performance of a flow battery can be realized. In particular, the higher positive reduction potential can allow improved open circuit potential, voltage efficiency and current efficiency values to be realized. The electrochemical kinetics for these types of compounds may also be substantially reversible, which can also be advantageous for flow batteries.

As another advantage, phenothiazine can be readily synthesized from low-cost starting materials and, as a result, is commercially available at a considerably lower cost than iron hexacyanide compounds. On a molar basis, the cost of phenothiazine is less than half that of iron hexacyanide compounds. The lower cost of phenothiazine and its compounds can significantly decrease the expense of constructing a flow battery. In addition, the relative ease with which the phenothiazine ring system can be prepared allows access to a wide breadth of phenothiazine derivatives that can have even more desirable properties, such as increased aqueous solubility. Like phenothiazine itself, many phenothiazine derivatives can be synthesized from low-cost reagents, and are similarly available at a cost below that of iron hexacyanide coordination compounds. Illustrative syntheses for preparing phenothiazine and related compounds are discussed in brief below.

The ready syntheses of phenothiazine compounds can allow further advantages to be realized. In some cases, the reduction potential of phenothiazine compounds can be adjusted through one's choice of additional functionality introduced into the phenothiazine ring system. Even more desirably, one or more functional groups can be introduced into the phenothiazine ring system to promote greater solubility in water or aqueous electrolyte solutions. Advantageously, such solubilizing functional groups can be introduced during formation of the phenothiazine ring system or afterward, either onto the aromatic rings and/or the secondary amine group of the central heterocyclic ring. Increased solubility of the phenothiazine compounds can desirably lower the volume of aqueous electrolyte solution needing to be circulated in the flow battery and/or increase the quantity of electrons that are transferred for a given volume of aqueous electrolyte solution.

As a further advantage, phenothiazine compounds can serve as a redox-active material in their free (uncomplexed) form, or they can be bonded to a metal center in a coordination compound. Coordination of a phenothiazine compound to a metal center can also improve aqueous solubility and/or tailor the reduction potential in some instances. In addition, because both the phenothiazine compound and the metal center can be redox-active, more electrons can be transferred on a molar basis during an oxidation-reduction cycle than with just the phenothiazine compound alone. Thus, even further increased energy density values can be realized when a phenothiazine compound is present in a coordination compound.

Before discussing further specifics of suitable phenothiazine compounds and flow batteries incorporating phenothiazine compounds, a brief discussion of flow batteries and their operating characteristics will first be provided so that the embodiments of the present disclosure can be better understood.

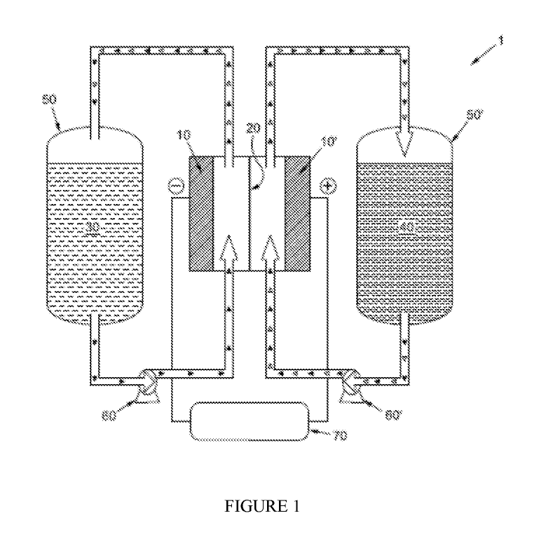

Unlike typical battery technologies (e.g., Li-ion, Ni-metal hydride, lead-acid, and the like), where redox-active materials and other components, such as electrolyte substances, are housed in a single assembly, flow batteries transport (e.g., via pumping) redox-active materials from receptacles (i.e., storage tanks) through an electrochemical stack containing one or more electrochemical cells. This design feature decouples the electrical energy storage system power from the energy storage capacity, thereby allowing for considerable design flexibility and cost optimization. FIG. 1 shows a schematic of an illustrative flow battery containing a single electrochemical cell. Although FIG. 1 shows a flow battery containing a single electrochemical cell, approaches for combining multiple electrochemical cells together are known and are discussed in brief hereinbelow. Active materials containing phenothiazine and related compounds can be incorporated in these and other types of flow batteries.

As shown in FIG. 1, flow battery includes an electrochemical cell that features separator 20 between electrodes 10 and 10′ in corresponding first and second half-cells, As used herein, the terms “separator” and “membrane” synonymously refer to an ionically conductive and electrically insulating material disposed between the positive and negative electrodes of an electrochemical cell. Electrodes 10 and 10′ are formed from a suitably conductive material, such as a metal, carbon, graphite, and the like, and the materials for the t can be the same or different. Although FIG. 1 has shown electrodes 10 and 10′ as being spaced apart from separator 20, electrodes 10 and 10′ can also be abutted with separator 20 in more particular embodiments, The material(s) forming electrodes 10 and 10′ can be porous, such that they have a high surface area for contacting first electrolyte solution 30 and second electrolyte solution 40, the active materials of which are capable of cycling between an oxidized stale and a reduced state during operation of flow battery 1. For example, one or both of electrodes 10 and 10′ can be formed from a porous carbon cloth or a carbon foam in particular embodiments.

Pump 60 affects transport of first electrolyte solution 30 containing a first active material from tank 50 to the electrochemical cell. The flow battery also suitably includes second tank 50′ that holds second electrolyte solution 40 containing a second active material. The second active material in second electrolyte solution 40 can be the same material as the first active material in first electrolyte solution 30, or it can be different. More desirably, the first and second active materials differ from one another. Second pump 60′ can similarly affect transport of second electrolyte solution 40 to the electrochemical cell. Pumps (not shown in FIG. 1) can also be used to affect transport of first and second electrolyte solutions 30 and 40 from the electrochemical cell back to tanks 50 and 50′. Electrolytes (i.e., mobile ions) in first and second electrolyte solutions 30 and 40 also circulate between the electrochemical cell and tanks 50 and 50′ in this process. Other methods of affecting fluid transport, such as siphons, for example, can also suitably transport first and second electrolyte solutions 30 and 40 into and out of the electrochemical cell. Also shown in FIG. 1 is power source or load 70, which completes the circuit of the electrochemical cell and allows a user to collect or store electricity during its operation. Connection to the electrical grid for charging or discharging purposes can also occur at this location.

It should be understood that FIG. 1 depicts a specific, non-limiting configuration of a particular flow battery. Accordingly, flow batteries consistent with the spirit of the present disclosure can differ in various aspects relative to the configuration of FIG. 1. As one example, a flow battery can include one or more active materials that are solids, gases, and/or gases dissolved in liquids. Active materials can be stored in a tank, in a vessel open to the atmosphere, or simply vented to the atmosphere. In particular embodiments, the active materials and the mobile ions remain continuously soluble in their respective electrolyte solution during operation of the flow battery. As used herein, the term “continuously soluble” refers to the condition of a dissolved component not undergoing precipitation or becoming associated with a solid (e.g., through intercalation) during operation of a flow battery.

During operation of a flow battery in a charging cycle, one of the active materials undergoes oxidation and the other active material undergoes reduction. In a discharging cycle, the opposite processes occur in each half-cell. Upon changing the oxidation states of the active materials, the chemical potentials of the electrolyte solutions are no longer in balance with one another. To relieve the chemical potential imbalance, dissolved mobile ions migrate through the separator to lower the charge in one electrolyte solution and to raise the charge in the other electrolyte solution. Thus, the mobile ions transfer the charge generated upon oxidizing or reducing the active materials, but the mobile ions themselves are not oxidized or reduced. To maintain facile electrode kinetics, the flow batteries are configured such that the mobile ions and the active materials remain continuously soluble in the electrolyte solutions. In addition, by keeping the mobile ions and the active materials continuously soluble in the electrolyte solutions, potential issues associated with circulating solids can be averted.

As indicated above, multiple electrochemical cells can also be combined with one another in an electrochemical stack in order to increase the rate that energy can be stored and released during operation. The amount of energy released is determined by the overall amount of active materials that are present. An electrochemical stack utilizes bipolar plates between adjacent electrochemical cells to establish electrical communication but not fluid communication between the two cells across the bipolar plate. Thus, bipolar plates contain the electrolyte solutions in an appropriate half-cell within the individual electrochemical cells. Bipolar plates are generally fabricated from electrically conductive materials that are fluidically non-conductive on the whole. Suitable materials can include carbon, graphite, metal, or a combination thereof. Bipolar plates can also be fabricated from non-conducting polymers having a conductive material dispersed therein, such as carbon particles or fibers, metal particles or fibers, graphene, and/or carbon nanotubes. Although bipolar plates can be fabricated from the same types of conductive materials as can the electrodes of an electrochemical cell, they can lack the continuous porosity permitting an electrolyte solution to flow completely through the latter. It should be recognized that bipolar plates are not necessarily entirely non-porous entities, however. Bipolar plates can have innate or designed flow channels that provide a greater surface area for allowing an electrolyte solution to contact the bipolar plate. Suitable flow channel configurations can include, for example, interdigitated flow channels. In some embodiments, the flow channels can be used to promote delivery of an electrolyte solution to an electrode within the electrochemical cell.

In some instances, an electrolyte solution can be delivered to and withdrawn from each electrochemical cell via a fluid inlet manifold and a fluid outlet manifold (not shown in FIG. 1). In some embodiments, the fluid inlet manifold and the fluid outlet manifold can provide and withdraw an electrolyte solution via the bipolar plates separating adjacent electrochemical cells. Separate manifolds can provide each electrolyte solution individually to the two half-cells of each electrochemical cell. In more particular embodiments, the fluid inlet manifold and the fluid outlet manifold can be configured to supply and withdraw the electrolyte solutions via opposing lateral faces of the bipolar plates (e.g. by supplying and withdrawing the electrolyte solution from opposing ends of the flow channels of the bipolar plate).

Accordingly, in various embodiments, the present disclosure provides flow batteries containing a phenothiazine compound, a sulfur-oxidized variant thereof, or a salt thereof in an aqueous electrolyte solution. More particularly, the present disclosure provides flow batteries including a first half-cell containing a first aqueous electrolyte solution, a first electrolyte receptacle in fluid communication with the first half-cell, a second half-cell containing a second aqueous electrolyte solution, a second electrolyte receptacle in fluid communication with the second half-cell, and a separator disposed between the first half-cell and the second half-cell. The first aqueous electrolyte solution contains a first redox-active material and first mobile ions that are each continuously soluble in the first aqueous electrolyte solution. The second aqueous electrolyte solution contains a second redox-active material and second mobile ions that are each continuously soluble in the second aqueous electrolyte solution. At least one of the first redox-active material and the second redox-active material is a phenothiazine compound, a sulfur-oxidized variant thereof, or a salt thereof. The flow battery is configured to circulate the first redox-active material and the first mobile ions between the first half-cell and the first electrolyte receptacle and the second redox-active material and the second mobile ions between the second half-cell and the second electrolyte receptacle.

In various embodiments, suitable salt forms for a phenothiazine compound can match the cation or the anion of the first or second mobile ions. For example, a positively charged phenothiazine salt can have a counteranion that is the same as the anion of the first or second mobile ions, and a negatively charged phenothiazine salt can have a countercation that is the same as the cation of the first or second mobile ions. More particularly, the salt form of the phenothiazine compound matches the salt form of the mobile ions in the electrolyte solution where the phenothiazine compound is present.

In particular embodiments, the first and second electrolyte receptacles can be first and second storage tanks, respectively. The first and second storage tanks, associated piping and the like contain quantities of the first and second aqueous electrolyte solutions that are not present in the first and second half-cells at a given point in time. The volumes of the first and second storage tanks are not considered to be particularly limited and can be chosen in response to the energy requirements for a given application.

In more specific embodiments, the phenothiazine compound or the salt thereof can have Structure 1 or Structure 2.

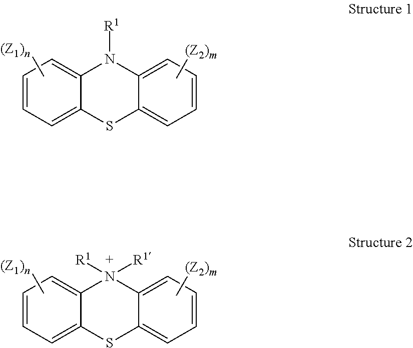

In other more specific embodiments, a sulfur-oxidized variant of a phenothiazine compound or a salt thereof can have any of Structures 3-6.

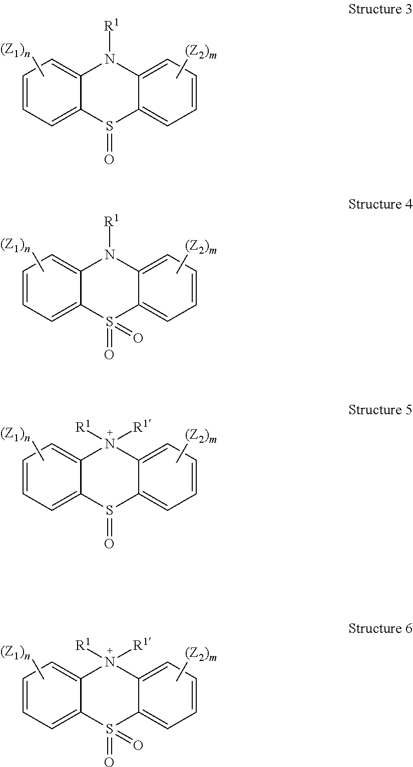

Description of the substituents in Structures 1-6 is provided in the paragraphs following hereinafter. In some embodiments, the substituents can be selected to affect the reduction potential, to promote complexation of a metal ion, and/or to promote solubility in a desired solvent, such as an aqueous electrolyte solution.

R¹ and R^{1′} are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; C₂-C₆ polyol; C(═O)R²; C(═O)OR³; and C(═O)NR⁴R⁵. In some embodiments, R¹ and R^{1′}, if present, are not H if all Z₁ and Z₂ are H.

In some embodiments, R² is selected from the group consisting of optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol. In some or other embodiments, R² is selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol.

R³ is selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol.

R⁴ and R⁵ are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol.

Z₁ and Z₂ are optional substitutions independently selected from the group consisting of H; optionally substituted alkyl, alkenyl, alkynyl, aryl, aralkyl, heterocyclyl, or heteroaryl; C₂-C₆ polyol; C(═O)R³; C(═O)OR³; C(═O)NR⁴R⁵; OR³; O(C═O)R³; SR³; S(═O)R³; S(═O)₂R³; NR⁴R⁵; NR⁴(C═O)R⁴; NR⁴(C═O)NR⁴R⁵; (CH₂)₁₋₁₀CO₂H; (CH₂)₁₋₁₀(CHOH)CO₂H; CH₂(OCH₂CH₂)ₓOCH₃; CH₂(OCH₂CH₂)ₓOCH₃; CH(OH)CH₂OH; halogen; nitro; cyano; sulfonyl; and perfluoroalkyl. In some embodiments, Z₁ and Z₂ constitute the same group, and in other embodiments, they are different. Moreover, in some embodiments, different Z₁ can be on the same aromatic ring, possible Z₁ being defined by the variables above. Likewise, in some embodiments, different Z₂ can be on the same aromatic ring, possible Z₂ being defined by the variables above. In some embodiments, at least one (Z₁)ₙ and/or (Z₂)ₘ are not H, particularly when R¹ is H. That is, in some embodiments, at least one of the aromatic rings in the phenothiazine ring system is substituted with a functional group that is not H, particularly when the phenothiazine nitrogen atom is unfunctionalized. In some or other embodiments, the two aromatic rings in the phenothiazine ring system are functionalized and bear different substituents and/or substitution patterns from one another. In some or other embodiments, the two aromatic rings in the phenothiazine ring system are functionalized and bear the same substituents and/or substitution patterns.

Variables n and m are integers independently ranging between 0 and 4. Variable x is an integer ranging between 0 and about 100.

As used herein, the term “alkyl” refers to a straight-chain, branched or cyclic carbon chain containing 1 to about 16 carbon atoms and no carbon-carbon unsaturation. As used herein, the term “carbon-carbon unsaturation” refers to a carbon-carbon double bond or triple bond.

As used herein, the term “alkenyl” refers to a straight-chain, branched or cyclic carbon chain containing 2 to about 16 carbon atoms and at least one carbon-carbon double bond. The at least one carbon-carbon double bond can be in any location in the carbon chain and in either the E or Z configuration.

As used herein, the term “alkynyl” refers to a straight-chain, branched or cyclic carbon chain containing 2 to about 16 carbon atoms and at least one carbon-carbon triple bond. The at least one carbon-carbon triple bond can be in any location in the carbon chain.

As used herein, the term “aryl” refers to a monocyclic or polycyclic aromatic group containing 6 to about 19 carbon atoms.

As used herein, the term “heteroaryl” refers to a monocylic or polycyclic aromatic group containing 5 to about 18 carbon atoms and at least one heteroatom within at least one of the aromatic groups. More specifically, the at least one heteroatom in a heteroaryl group can be O, N or S.

As used herein, the term “heterocyclyl” refers to a monocyclic or polycyclic group containing 3 to about 10 carbon atoms that is non-aromatic and contains at least one heteroatom within at least one ring.

As used herein, the term “aralkyl” refers an alkyl group in which at least one hydrogen atom has been replaced by an aryl or heteroaryl group.

As used herein, the term “polyol” refers to any compound having two or more alcohol functional groups. Additional heteroatom functionality, such as amines and carboxylic acids, can optionally be present within a polyol. Thus, amino alcohol and hydroxy acid analogues of unmodified glycols and higher polyols are also encompassed by the term “polyol.” Any of the alcohol, amine and/or carboxylic acid functional groups can be used to form a bond to the phenothiazine compounds in Structures 1-6. Some illustrative polyols can include monosaccharides. As used herein, term “monosaccharide” refers to both the base monosaccharide and the corresponding sugar alcohols, sugar acids, and deoxy sugars of the base monosaccharide, including any open- or closed-chain forms of these materials. Illustrative polyols include, for example, 1,2-ethanediol (ethylene glycol), 1,2-propanediol (propylene glycol), 1,3-propanediol, 1,2-butanediol, 1,4-butanediol, glycerol, erythritol, threitol, arabitol, xylitol, ribitol, mannitol, sorbitol, galacitol, fucitol, iditol, inositol, glycolaldehyde, glyceraldehyde, 1,3-dihydroxyacetone, erythrose, threose, erythrulose, arabinose, ribose, lyxose, xylose, ribulose, xylulose, allose, altrose, glucose, mannose, gulose, idose, galactose, talose, psicose, fructose, sorbose, tagatose, deoxyribose, rhamnose, fucose, glyceric acid, xylonic acid, gluconic acid, ascorbic acid, glucuronic acid, galacturonic acid, iduronic acid, tartartic acid, galactaric acid, and glucaric acid.

As used herein, the term “perfluoroalkyl” refers to an alkyl group that has at least 50% of its hydrogen atoms replaced by fluoro groups. In some embodiments, at least about 90% of the hydrogen atoms are replaced by fluoro groups, and in some embodiments, all of the hydrogen atoms are replaced by fluoro groups.

As used herein, the term “optionally substituted” refers to an alkyl, alkenyl, alkynyl, aryl, aralkyl, heterocyclyl, or heteroaryl group being either unsubstituted or bearing at least one heteroatom substituent. As used herein, the term “heteroatom substituent” refers to a functional group containing one or more O, N or S atoms, or a halogen atom. As used herein, the term “halogen” refers to F, Cl, Br or I. Illustrative heteroatom substituents that can optionally be present include, but are not limited to, hydroxyl, alkoxy, cyano, nitro, carboxyl, carboxamide, carboxylic ester, carbonyl, amine, ether, sulfonyl, fluoro, chloro, bromo, iodo, and trihaloalkyl. In the case of a carbon chain, the at least one heteroatom substituent can either be appended from the carbon chain and/or replace one or more of the carbon atoms within the carbon chain. In the case of a heterocyclic or heteroaromatic ring, the at least one heteroatom substituent can be appended from the heterocyclic or heteroaromatic ring.

In non-limiting embodiments, a phenothiazine compound of Formula 1 can be prepared with N-functionalization by reacting phenothiazine with a suitable nucleophile in the presence of a base, such as sodium carbonate. In other non-limiting embodiments, a sulfonated phenothiazine compound of Formula 1 can be prepared by reacting one or more of the aromatic rings with a quantity of sulfuric acid. In still other non-limiting embodiments, phenothiazine or substituted phenothiazine compounds of Formula 1 can be prepared by reacting aniline and/or a substituted aniline to form a diarylamine and then closing the central heterocyclic ring by heating in the presence of sulfur. Alternately, the diarylamine can be sourced separately and directly reacted with sulfur to form the central heterocyclic ring. By incorporating suitable substitution on the aniline and/or the diarylamine, phenothiazine compounds functionalized on the phenyl rings can be prepared.

In some embodiments, the first redox-active material or the second redox-active material can be an unbound form of the phenothiazine compound, the sulfur-oxidized variant thereof, or the salt thereof. In other embodiments, the first redox-active material or the second redox-active material can be a coordination compound containing the phenothiazine compound, the sulfur-oxidized variant thereof, or the salt thereof as at least one ligand. When present as a ligand, suitable functionality for complexing or chelating a metal center can be present upon the phenothiazine ring system, particularly upon at least one of the aromatic rings. In some embodiments, the metal center of a coordination compound in which a phenothiazine-based ligand is present can be a titanium metal center.

In some more specific embodiments, only one of the first aqueous electrolyte solution and the second aqueous electrolyte solution contains the phenothiazine compound, the sulfur-oxidized variant thereof, or the salt thereof. Again, the phenothiazine compound, oxidized variant thereof, or salt thereof can be in a free form or an unbound form.

In more particular embodiments, the phenothiazine compound, the sulfur-oxidized variant thereof, or the salt thereof can be present in the first aqueous electrolyte solution. In still more particular embodiments, the first aqueous electrolyte solution can be present in the first half-cell of the flow battery, where the first half-cell is a positive half-cell. As such, the phenothiazine compound, the sulfur-oxidized variant thereof, or the salt thereof can constitute the positive active material in the flow battery and replace other positive active materials, such as iron hexacyanide coordination compounds.

In further embodiments, in which the phenothiazine compound, the sulfur-oxidized variant thereof, or the salt thereof is present in a positive half-cell of the flow battery, the second half-cell can be a negative half-cell of the flow battery and contain a second redox-active material that is a coordination compound. Suitable coordination compounds for the second redox-active material can include those described hereinafter. Particularly suitable coordination compounds for use as the second redox-active material can be titanium coordination compounds, although other coordination compounds containing other metals can also be utilized.

In some embodiments, coordination compounds suitable for use as the second redox-active material can have a formula of

D_{g}M(L¹)(L²)(L³),

wherein M is a transition metal; D is ammonium, tetraalkylammonium (C₁-C₄ alkyl), an alkali metal ion (e.g., Li⁺, Na⁺and/or K⁺), or any combination thereof; g ranges between 0 and 6; and L¹, L² and L³ are ligands. In some embodiments, at least one of L¹, L² and L³ can be a catecholate ligand or substituted catecholate ligand, and in other embodiments, each of L¹, L² and L³ can be a catecholate ligand or substituted catecholate ligand. Suitable substituted catecholate ligand can include, for example, monosulfonated catecholate ligands, hydroxylated catecholate ligands, or carboxylated catecholate ligands. Catecholate ligands can be especially desirable to include in a coordination compound serving as an active material in a flow battery due to the relatively good aqueous solubility of these groups, their ready complexation of metals, and their contribution to a high negative half-cell potential when present.

When less than all the open coordination sites are filled in the coordination compounds, one or more additional ligands can be present. Suitable additional ligands that can be present include, for example, an unsubstituted catecholate, a substituted catecholate, ascorbate, citrate, glycolate, a polyol, gluconate, hydroxyalkanoate, acetate, formate, benzoate, malate, maleate, phthalate, sarcosinate, salicylate, oxalate, urea, polyamine, aminophenolate, acetylacetonate, and lactate. Where chemically feasible, it is to be recognized that the ligands defined in the foregoing lists can be optionally substituted with at least one group selected from among C₁₋₆ alkoxy, C₁₋₆ alkyl, C₁₋₆ alkenyl, C₁₋₆ alkynyl, 5- or 6-membered aryl or heteroaryl groups, a boronic acid or a derivative thereof, a carboxylic acid or a derivative thereof, cyano, halide, hydroxyl, nitro, sulfonate, a sulfonic acid or a derivative thereof, a phosphonate, a phosphonic acid or a derivative thereof, or a glycol, such as polyethylene glycol. Alkanoate includes any of the alpha, beta, and gamma forms of these ligands. Polyamines include, but are not limited to, ethylenediamine, ethylenediamine tetraacetic acid (EDTA), and diethylenetriamine pentaacetic acid (DTPA). Still other examples of additional ligands that can be present include, for example, carbonyl or carbon monoxide, nitride, oxo, hydroxo, water, sulfide, thiols, pyridine, pyrazine, bipyrazine, ethylenediamine, diols (including ethylene glycol), terpyridine, diethylenetriamine, triazacyclononane, tris(hydroxymethyl)aminomethane, and the like

Due to their variable oxidation states, transition metals can be highly desirable for incorporation within the second redox-active material of the flow batteries described herein. Lanthanide elements can be used similarly in this regard. In general, any transition metal or lanthanide metal can be present as the metal center in the coordination compounds of the present disclosure. In more specific embodiments, the metal center can be a transition metal selected from among Al, Cr, Ti and Fe. For purposes of the present disclosure, Al is to be considered a transition metal. In more specific embodiments, the transition metal can be Ti. Other suitable transition and main group metals that can be present in the coordination compounds of the present disclosure include, for example, Ca, Ce, Co, Cu, Mg, Mn, Mo, Ni, Pb, Pd, Pt, Ru, Sb, Sr, Sn, V, Zn, Zr, and any combination thereof. In various embodiments, the coordination compounds can include a transition metal in a non-zero oxidation state when the transition metal is in both its oxidized and reduced forms. Cr, Fe, Mn, Ti and V can be particularly desirable in this regard.

The aqueous electrolyte solutions of the present disclosure, in which the phenothiazine compound, the sulfur-oxidized variant thereof, or the salt thereof is present, will now be discussed in further detail.

As used herein, the term “aqueous electrolyte solution” refers to a homogeneous liquid phase with water as a predominant solvent in which an active material is solubilized. This definition encompasses both solutions in water and solutions containing a water-miscible organic solvent as a minority component of an aqueous phase.

Illustrative water-miscible organic solvents that can be present in an aqueous electrolyte solution of the present disclosure include, for example, alcohols and glycols, optionally in the presence of one or more surfactants or other components discussed below. In more specific embodiments, an aqueous electrolyte solution can contain at least about 98% water by weight. In other more specific embodiments, an aqueous electrolyte solution can contain at least about 55% water by weight, or at least about 60% water by weight, or at least about 65% water by weight, or at least about 70% water by weight, or at least about 75% water by weight, or at least about 80% water by weight, or at least about 85% water by weight, or at least about 90% water by weight, or at least about 95% water by weight. In some embodiments, an aqueous electrolyte solution of the present disclosure can be free of water-miscible organic solvents and consist of water alone as a solvent.

In further embodiments, an aqueous electrolyte solution of the present disclosure can include a viscosity modifier, a wetting agent, or any combination thereof. Suitable viscosity modifiers can include, for example, corn starch, corn syrup, gelatin, glycerol, guar gum, pectin, and the like. Other suitable examples will be familiar to one having ordinary skill in the art. Suitable wetting agents can include, for example, various non-ionic surfactants and/or detergents. In some or other embodiments, an aqueous electrolyte solution can further include a glycol or a polyol. Suitable glycols can include, for example, ethylene glycol, diethylene glycol, and polyethylene glycol. Suitable polyols can include, for example, glycerol, mannitol, sorbitol, pentaerythritol, and tris(hydroxymethyl)aminomethane. Inclusion of any of these components in an aqueous electrolyte solution of the present disclosure can help promote dissolution of a phenothiazine compound or a coordination compound and/or reduce viscosity of the aqueous electrolyte solution for conveyance through a flow battery, for example.

In some embodiments, an aqueous electrolyte solution in which a phenothiazine compound, an oxidized variant thereof, or a salt thereof is present can have an acidic pH. In more particular embodiments, the pH can range between about 1 and about 6, or between about 4 and about 6.5, or between about 3 and about 6, or between about 2 and about 5. Acidic aqueous electrolyte solutions can protonate the nitrogen atom of the phenothiazine ring system in some cases, and the resulting salt can display improved solubility over the neutral compound. In alternative embodiments, an aqueous electrolyte solution in which a phenothiazine compound, an oxidized variant thereof, or a salt thereof is present can have an alkaline pH. Illustrative alkaline pH values can range between 8 and about 14, or between about 12 and about 14, or between about 9 and about 12, or between about 7.5 and about 11.

In some or other illustrative embodiments, an aqueous electrolyte solution in which a coordination compound is present can have an alkaline pH. Alkaline pH values can be especially suitable for maintaining stability of coordination compounds containing catecholate ligands, for example. In more particular embodiments, the pH can range between about 8 and about 14, or between about 12 and about 14, or between about 9 and about 12, or between about 7.5 and about 11. In alternative embodiments, an aqueous electrolyte solution in which a coordination compound is present can have an acidic pH, including the acid pH ranges discussed above for the aqueous electrolyte solution in which the phenothiazine compound, an oxidized variant thereof, or a salt thereof is present.

In certain embodiments, the first aqueous electrolyte solution can have an acidic pH, and the second aqueous electrolyte solution can have an alkaline pH. In other embodiments, the pH of both aqueous electrolyte solutions can be chosen such that they are each acidic or each alkaline. In some embodiments, the pH of both aqueous electrolyte solutions can be within about 2 pH units of each other.

In addition to a solvent and a redox-active material, the aqueous electrolyte solutions can also include one or more mobile ions. In some embodiments, suitable mobile ions can include proton, hydronium, or hydroxide. In other various embodiments, mobile ions other than proton, hydronium, or hydroxide can be present, either alone or in combination with proton, hydronium or hydroxide. Such alternative mobile ions can include, for example, alkali metal or alkaline earth metal cations (e.g., Li⁺, Na⁺, Mg²⁺, Ca²⁺ and Sr²⁺) and halides (e.g., F⁺, Cl⁺, or Br⁺). In some embodiments, alkali metal halides can be particularly suitable salts for supplying the mobile ions. Other suitable mobile ions can include, for example, ammonium and tetraalkylammonium ions, chalcogenides, phosphate, hydrogen phosphate, phosphonate, nitrate, sulfate, nitrite, sulfite, perchlorate, tetrafluoroborate, hexafluorophosphate, and any combination thereof. In some embodiments, less than about 50% of the mobile ions can constitute protons, hydronium, or hydroxide. In other various embodiments, less than about 40%, less than about 30%, less than about 20%, less than about 10%, less than about 5%, or less than about 2% of the mobile ions can constitute protons, hydronium, or hydroxide.

In various embodiments, a concentration of the redox-active material in an aqueous electrolyte solution can range between about 0.1 M and about 3 M. This concentration range represents the sum of the individual concentrations of the oxidized and reduced forms of the redox-active material. In more particular embodiments, the concentration of the redox-active material can range between about 0.5 M and about 3 M, or between 1 M and about 3 M, or between about 1.5 M and about 3 M, or between 1 M and about 2.5 M.

Illustrative flow battery configurations and methods that can incorporate the foregoing aqueous electrolyte solutions will now be described in further detail. The flow batteries of the present disclosure are, in some embodiments, suited to sustained charge or discharge cycles of several hour durations. As such, they can be used to smooth energy supply/demand profiles and provide a mechanism for stabilizing intermittent power generation assets (e.g., from renewable energy sources such as solar and wind energy). It should be appreciated, then, that various embodiments of the present disclosure include energy storage applications where such long charge or discharge durations are desirable. For example, in non-limiting examples, the flow batteries of the present disclosure can be connected to an electrical grid to allow renewables integration, peak load shifting, grid firming, baseload power generation and consumption, energy arbitrage, transmission and distribution asset deferral, weak grid support, frequency regulation, or any combination thereof. When not connected to an electrical grid, the flow batteries of the present disclosure can be used as power sources for remote camps, forward operating bases, off-grid telecommunications, remote sensors, the like, and any combination thereof. Further, while the disclosure herein is generally directed to flow batteries, it is to be appreciated that other electrochemical energy storage media can incorporate the electrolyte solutions and coordination compounds described herein, specifically those utilizing stationary electrolyte solutions.

In some embodiments, flow batteries of the present disclosure can include: a first chamber containing a positive electrode contacting a first aqueous electrolyte solution; a second Chamber containing a negative electrode contacting a second aqueous electrolyte solution, and a separator disposed between the first and second electrolytes solutions. The chambers provide separate reservoirs within the cell, through which the first and/or second aqueous electrolyte solutions circulate so as to contact the respective electrodes and the separator. Each chamber and its associated electrode and electrolyte solution define a corresponding half-cell. The separator provides several functions which include, for example, (1) serving as a barrier to mixing of the first and second electrolyte solutions, (2) electrically insulating to reduce or prevent short circuits between the positive and negative electrodes, and (3) to facilitate ion transport between the positive and negative electrolyte chambers, thereby balancing electron transport during charge and discharge cycles. The negative and positive electrodes provide a surface where electrochemical reactions can take place during charge and discharge cycles. During a charge or discharge cycle, electrolyte solutions can be transported from separate storage tanks through the corresponding chambers. The mobile ions of the electrolyte solutions remain continuously soluble during this process. In a charging cycle, electrical power can be applied to the electrochemical cell such that the redox-active material contained in the second electrolyte solution undergoes a one or more electron oxidation and the redox-active material in the first electrolyte solution undergoes a one or more electron reduction. Similarly, in a discharge cycle the second redox-active material s reduced and the first redox-active material is oxidized to generate electrical power,

In more specific embodiments, illustrative flow batteries of the present disclosure can include: (a) a first aqueous electrolyte solution containing a first redox-active material; (b) a second aqueous electrolyte solution containing a second redox-active material; (c) a separator positioned between said first and second aqueous electrolyte solutions; and (d) mobile ions in the first and second aqueous electrolyte solutions. As described in more detail below, the separator can be an ionomer membrane, and it can have a thickness of less than 100 microns. In some embodiments, an ionomer membrane can have an associated net charge that is the same sign as that of the first and second redox-active materials.

Polymer membranes can be anion- or cation-conducting electrolytes. Where described as an “ionomer,” the term refers to polymer membrane containing both electrically neutral repeating units and ionized repeating units, where the ionized repeating units are pendant and covalently bonded to the polymer backbone. In general, the fraction of ionized units can range from about 1 mole percent to about 90 mole percent. For example, in some embodiments, the content of ionized units is less than about 15 mole percent; and in other embodiments, the ionic content is higher, such as greater than about 80 mole percent. In still other embodiments, the ionic content is defined by an intermediate range, for example, in a range of about 15 to about 80 mole percent. Ionized repeating units in an ionomer can include anionic functional groups such as sulfonate, carboxylate, and the like. These functional groups can be charge balanced by, mono-, di-, or higher-valent cations, such as alkali or alkaline earth metals. lonomers can also include polymer compositions containing attached or embedded quaternary ammonium, sulfonium, phosphazenium, and guanidinium residues or salts. Suitable examples will be familiar to one having ordinary skill in the art.

In some embodiments, polymers useful as a separator can include highly fluorinated or perfluorinated polymer backbones. Certain polymers useful in the present disclosure can include copolymers of tetrafluoroethylene and one or more fluorinated, acid-functional co-monomers, which are commercially available as NAFION™ perfluorinated polymer electrolytes from DuPont. Other useful perfluorinated polymers can include copolymers of tetrafluoroethylene and FSO₂—CF₂CF₂CF₂CF₂—O—CF═CF₂, FLEMION™ and SELEMION™.

Additionally, substantially non-fluorinated membranes that are modified with sulfonic acid groups (or cation exchanged sulfonate groups) can also be used. Such membranes can include those with substantially aromatic backbones such as, for example, polystyrene, polyphenylene, biphenyl sulfone (BPSH), or thermoplastics such as polyetherketones and poly ethersulfones.

Battery-separator style porous membranes, can also be used as the separator. Because they contain no inherent ionic conduction capabilities, such membranes are typically impregnated with additives in order to function. These membranes typically contain a mixture of a polymer and inorganic filler, and open porosity. Suitable polymers can include, for example, high density polyethylene, polypropylene, polyvinylidene difluoride (PVDF), or polytetrafluoroethylene (PTFE). Suitable inorganic fillers can include silicon carbide matrix material, titanium dioxide, silicon dioxide, zinc phosphide, and ceria.

Separators can also be formed from polyesters, polyetherketones, polyvinyl chloride), vinyl polymers, and substituted vinyl polymers. These can be used alone or in combination with any previously described polymer.

Porous separators are non-conductive membranes which allow charge transfer between two electrodes via open channels filled with electrolyte. The permeability increases the probability of chemicals (e.g., redox-active materials) passing through the separator from one electrode to another and causing cross-contamination and/or reduction in cell energy efficiency. The degree of this cross-contamination can depend on, among other features, the size (the effective diameter and channel length), and character (hydrophobicity/hydrophilicity) of the pores, the nature of the electrolyte, and the degree of wetting between the pores and the electrolyte.

The pore size distribution of a porous separator is generally sufficient to substantially prevent the crossover of redox-active materials between the two electrolyte solutions. Suitable porous membranes can have an average pore size distribution of between about 0.001 nm and 20 micrometers, more typically between about 0.001 nm and 100 nm. The size distribution of the pores in the porous membrane can be substantial. In other words, a porous membrane can contain a first plurality of pores with a very small diameter (approximately less than 1 nm) and a second plurality of pores with a very large diameter (approximately greater than 10 micrometers). The larger pore sizes can lead to a higher amount of active material crossover. The ability for a porous membrane to substantially prevent the crossover of active materials can depend on the relative difference in size between the average pore size and the active material. For example, when the active material is a metal center in a coordination compound, the average diameter of the coordination compound can be about 50% greater than the average pore size of the porous membrane. On the other hand, if a porous membrane has substantially uniform pore sizes, the average diameter of the coordination compound can be about 20% larger than the average pore size of the porous membrane. Likewise, the average diameter of a coordination compound is increased when it is further coordinated with at least one water molecule. The diameter of a coordination compound of at least one water molecule is generally considered to be the hydrodynamic diameter. In such embodiments, the hydrodynamic diameter is generally at least about 35% greater than the average pore size. When the average pore size is substantially uniform, the hydrodynamic radius can be about 10% greater than the average pore size.

In some embodiments, the separator can also include reinforcement materials for greater stability. Suitable reinforcement materials can include nylon, cotton, polyesters, crystalline silica, crystalline titania, amorphous silica, amorphous titania, rubber, asbestos, wood or any combination thereof

Separators within the flow batteries of the present disclosure can have a membrane thickness of less than about 500 micrometers, or less than about 300 micrometers, or less than about 250 micrometers, or less than about 200 micrometers, or less than about 100 micrometers, or less than about 75 micrometers, or less than about 50 micrometers, or less than about 30 micrometers, or less than about 25 micrometers, or less than about 20 micrometers, or less than about 15 micrometers, or less than about 10 micrometers. Suitable separators can include those in which the flow battery is capable of operating with a current efficiency of greater than about 85% with a current density of 100 mA/cm² when the separator has a thickness of 100 micrometers. In further embodiments, the flow battery is capable of operating at a current efficiency of greater than 99.5% when the separator has a thickness of less than about 50 micrometers, a current efficiency of greater than 99% when the separator has a thickness of less than about 25 micrometers, and a current efficiency of greater than 98% when the separator has a thickness of less than about 10 micrometers. Accordingly, suitable separators include those in which the flow battery is capable of operating at a voltage efficiency of greater than 60% with a current density of 100 mA/cm². In further embodiments, suitable separators can include those in which the flow battery is capable of operating at a voltage efficiency of greater than 70%, greater than 80% or even greater than 90%.

The diffusion rate of the first and second redox-active materials through the separator can be less than about 1×10⁻⁵ mol cm⁻² day⁻¹, or less than about 1×10⁻⁶ mol cm⁻² day⁻¹, or less than about 1×10⁻⁷ mol cm⁻² day⁻¹, or less than about 1×10⁻⁹ mol cm⁻² day⁻¹, or less than about 1×10⁻¹¹ mol cm⁻² day⁻¹, or less than about 1×10⁻¹³ mol cm⁻² day⁻¹, or less than about 1×10⁻¹⁵ mol cm⁻² day⁻¹.

The flow batteries can also include an external electrical circuit in electrical communication with the first and second electrodes. The circuit can charge and discharge the flow battery during operation. Reference to the sign of the net ionic charge of the first, second, or both redox-active materials relates to the sign of the net ionic charge in both oxidized and reduced forms of the redox-active materials under the conditions of the operating flow battery. Further exemplary embodiments of a flow battery provide that (a) the first redox-active material has an associated net positive or negative charge and is capable of providing an oxidized or reduced form over an electric potential in a range the negative operating potential of the system, such that the resulting oxidized or reduced form of the first redox-active material has the same charge sign (positive or negative) as the first redox-active material and the ionomer membrane also has a net ionic charge of the same sign; and (b) the second redox-active material has an associated net positive or negative charge and is capable of providing an oxidized or reduced form over an electric potential in a range of the positive operating potential of the system, such that the resulting oxidized or reduced form of the second redox-active material has the same charge sign (positive or negative sign) as the second redox-active material and the ionomer membrane also has a net ionic charge of the same sign; or both (a) and (b). The matching charges of the first and/or second redox-active materials and the ionomer membrane can provide a high selectivity. More specifically, charge matching can provide less than about 3%, less than about 2%, less than about 1%, less than about 0.5%, less than about 0.2%, or less than about 0.1% of the molar flux of ions passing through the ionomer membrane as being attributable to the first or second redox-active material. The term “molar flux of ions” will refer to the amount of ions passing through the ionomer membrane, balancing the charge associated with the flow of external electricity/electrons, That is, the flow battery is capable of operating or operates with the exclusion or substantial exclusion of the active materials by the ionomer membrane through judicious charge matching.

Flow batteries incorporating the electrolyte solutions of the present disclosure can have one or more of the following operating characteristics: (a) where, during the operation of the flow battery, the first or second redox-active materials comprise less than about 3% of the molar flux of ions passing through the ionoiner membrane; (b) where, the round trip current efficiency is greater than about 70%, greater than about 80%, or greater than about 90%; (c) where the round trip current efficiency is greater than about 90%; (d) where the sign of the net ionic charge of the first, second, or both redox-active materials is the same in both oxidized and reduced forms of the redox-active materials and matches that of the ionomer membrane; (e) where the ionomer membrane has a thickness of less than about 100 μm, less than about 75 μm, less than about 50 μm, or less than about 250 μm; (f) where the flow battery is capable of operating at a current density of greater than about 100 mA/cm² with a round trip voltage efficiency of greater than about 60%; and (g) where the energy density of the electrolyte solutions is greater than about 10 Wh/L, greater than about 20 Wh/L, or greater than about 30 Wh/L.

In some cases, a user may desire to provide higher charge or discharge voltages than are available from a single electrochemical cell. In such cases, several electrochemical cells can be connected in series such that the voltage of each cell is additive. This forms a bipolar stack. An electrically conductive, but non-porous material (e.g., a bipolar plate) can be employed to connect adjacent battery cells in a bipolar stack, which allows for electron transport but prevents fluid or gas transport between adjacent cells. The positive electrode compartments and negative electrode compartments of individual cells can be fluidically connected via. common positive and negative fluid distribution manifolds in the stack. In this way, individual cells can be stacked in series to yield a voltage appropriate for DC applications or conversion to AC applications.

In additional embodiments, the cells, cell stacks, or batteries can be incorporated into larger energy storage systems, suitably including piping and controls useful for operation of these large units. Piping, control, and other equipment suitable for such systems are known in the art, and can include, for example, piping and pumps in fluid communication with the respective chambers for moving electrolyte solutions into and out of the respective chambers and storage tanks for holding charged and discharged electrolytes. The cells, cell stacks, and batteries of this disclosure can also include an operation management system. The operation management system can be any suitable controller device, such as a computer or microprocessor, and can contain logic circuitry that sets operation of any of the various valves, pumps, circulation loops, and the like.

In more specific embodiments, a flow battery system can include a flow battery (including a cell or cell stack); storage tanks and piping for containing and transporting the electrolyte solutions; control hardware and software (which may include safety systems); and a power conditioning unit. The flow battery cell stack accomplishes the conversion of charging and discharging cycles and determines the peak power, The storage tanks contain the positive and negative active materials, and the tank volume determines the quantity of energy stored in the system. The control software, hardware, and optional safety systems suitably include sensors, mitigation equipment and other electronic/hardware controls and safeguards to ensure safe, autonomous, and efficient operation of the flow battery system. A power conditioning unit can be used at the front end of the energy storage system to convert incoming and outgoing power to a voltage and current that is optimal for the energy storage system or the application, For the example of an energy storage system connected to an electrical grid, in a charging cycle the power conditioning unit can convert incoming AC electricity into DC electricity at an appropriate voltage and current for the cell stack. In a discharging cycle, the stack produces DC electrical power and the power conditioning unit converts it to AC electrical power at the appropriate voltage and frequency for grid applications.

Where not otherwise defined hereinabove or understood by one having ordinary skill in the art, the definitions in the following paragraphs are applicable to the present disclosure.

As used herein, the term “energy density” refers to the amount of energy that can be stored, per unit volume, in the active materials. Energy density refers to the theoretical energy density of energy storage and can be calculated by Equation 1:

Energy density=(26.8 A-h/mol)×OCV×[e⁻] (Equation 1)

where OCV is the open circuit potential at 50% state of charge (i.e., the difference in reduction potentials under the condition of the cell), (26.8 A-h/mol) is Faraday's constant, and [e⁻] is the concentration of electrons stored in the active material at 99% state of charge. In the case that the active materials largely are an atomic or molecular species for both the positive and negative electrolyte, [e⁻] can be calculated by Equation 2 as:

[e⁻]=[active materials]×N/2 (Equation 2)

where [active materials] is the molar concentration of the active material in either the negative or positive electrolyte, whichever is lower, and N is the number of electrons transferred per molecule of active material. The related term “charge density” refers to the total amount of charge that each electrolyte contains. For a given electrolyte, the charge density can be calculated by Equation 3

Charge density=(26.8 A-h/mol)×[active material]×N (Equation 3)

where [active material] and N are as defined above.

As used herein, the term “current density” refers to the total current passed in an electrochemical cell divided by the geometric area of the electrodes of the cell and is commonly reported in units of mA/cm².

As used herein, the term “current efficiency” (I_{eff}) can be described as the ratio of the total charge produced upon discharge of a cell to the total charge passed during charging. The current efficiency can be a function of the state of charge of the flow battery. In some non-limiting ebodiments, the current efficiency can be evaluated over a state of charge range of about 35% to about 60%.

As used herein, the term “voltage efficiency” can be described as the ratio of the observed electrode potential, at a given current density, to the half-cell potential for that electrode (×100%). Voltage efficiencies can be described for a battery charging step, a discharging step, or a “round trip voltage efficiency.” The round trip voltage efficiency (V_{eff,RT}) at a given current density can be calculated from the cell voltage at discharge (V_{discharge}) and the voltage at charge (V_{charge}) using Equation 4:

V_{eff,RT}=V_{discharge}/V_{charge}×100% (Equation 4)

As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to a reversible hydrogen electrode. The positive electrode is associated with a first electrolyte solution and the negative electrode is associated with a second electrolyte solution, as described herein. The electrolyte solutions associated with the negative and positive electrodes may be described as negolytes and posolytes, respectively.

Although the disclosure has been described with reference to the disclosed embodiments, those skilled in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

What is claimed is the following:

1. A flow battery comprising:
a first half-cell containing a first aqueous electrolyte solution, the first aqueous electrolyte solution comprising a first redox-active material and first mobile ions that are each continuously soluble in the first aqueous electrolyte solution;
a first electrolyte receptacle in fluid communication with the first half-cell;
a second half-cell containing a second aqueous electrolyte solution, the second aqueous electrolyte solution comprising a second redox-active material and second mobile ions that are each continuously soluble in the second aqueous electrolyte solution;
a second electrolyte receptacle in fluid communication with the second half-cell; and
a separator disposed between the first half-cell and the second half-cell;
wherein at least one of the first redox-active material and the second redox-active material comprises a phenothiazine compound, a sulfur-oxidized variant thereof, or a salt thereof; and
wherein the flow battery is configured to circulate the first redox-active material and the first mobile ions between the first half-cell and the first electrolyte receptacle and the second redox-active material and the second mobile ions between the second half-cell and the second electrolyte receptacle.

2. The flow battery of claim 1, wherein the first electrolyte receptacle comprises a first storage tank and the second electrolyte receptacle comprises a second storage tank.

3. The flow battery of claim 1, wherein only one of the first aqueous electrolyte solution and the second aqueous electrolyte solution comprises the phenothiazine compound, the sulfur-oxidized variant thereof, or the salt thereof

4. The flow battery of claim 3, wherein the phenothiazine compound, the sulfur-oxidized variant thereof, or the salt thereof is present in the first aqueous electrolyte solution.

5. The flow battery of claim 4, wherein the first redox-active material comprises a phenothiazine compound or a salt thereof.

6. The flow battery of claim 5, wherein the phenothiazine compound has a structure of 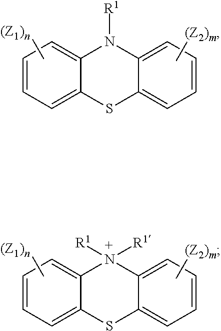
wherein R¹ and R^{1′} are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; C₂-C₆ polyol; C(═O)R²; C(═O)OR³; and C(═O)NR⁴R⁵;
wherein R² is selected from the group consisting of optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol;
wherein R³ is selected from the group consisting of H; optionally substituted alkyl, alkenyl, alkynyl, aryl, aralkyl, heterocyclyl, or heteroaryl; (CH₂)₁₋₁₀CO₂H; (CH₂)₁₋₁₀(CHOH)CO₂H; perfluoroalkyl; (CH₂CH₂O)ₓCH₃; CH₂(OCH₂CH₂)ₓOCH₃; CH(OH)CH₂OH; and C₂-C₆ polyol;
wherein R⁴ and R⁵ are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol; and
wherein x is an integer ranging between 0 and about 100; and
wherein Z₁ and Z₂ are optional substitutions independently selected from the group consisting of H; optionally substituted alkyl, alkenyl, alkynyl, aryl, aralkyl, heterocyclyl, or heteroaryl; C₂-C₆ polyol; C(═O)R³; C(═O)OR³; C(═O)NR⁴R⁵; OR³; O(C═O)R³; SR³; S(═O)R³; S(═O)₂R³; NR⁴R⁵; NR⁴C(═O)R⁴; NR⁴C(═O)NR⁴R⁵; (CH₂)₁₋₁₀CO₂H; (CH₂)₁₋₁₀(CHOH)CO₂H; CH₂(OCH₂CH₂)ₓOCH₃; CH₂(OCH₂CH₂)ₓOCH₃; CH(OH)CH₂OH; halogen; nitro; cyano; sulfonyl; and perfluoroalkyl; and
wherein n and m are integers independently ranging between 0 and 4.

7. The flow battery of claim 4, wherein the first redox-active material comprises a sulfur-oxidized variant of a phenothiazine compound, or a salt thereof

8. The flow battery of claim 7, wherein the sulfur-oxidized variant of the phenothiazine compound has a structure of 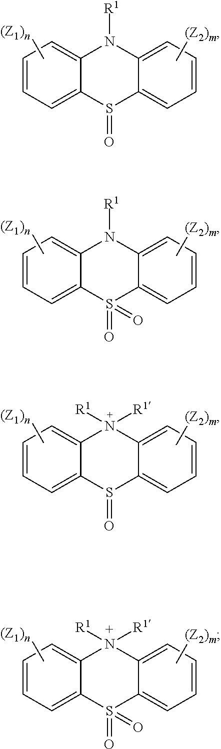
wherein R¹ and R^{1′} are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; C₂-C₆ polyol; C(═O)R²; C(═O)OR³; and C(═O)NR⁴R⁵;
wherein R² is selected from the group consisting of optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol;
wherein R³ is selected from the group consisting of H; optionally substituted alkyl, alkenyl, alkynyl, aryl, aralkyl, heterocyclyl, or heteroaryl; (CH₂)₁₋₁₀CO₂H; (CH₂)₁₋₁₀(CHOH)CO₂H; perfluoroalkyl; (CH₂CH₂O)ₓCH₃; CH₂(OCH₂CH₂)ₓOCH₃; CH(OH)CH₂OH; and C₂-C₆ polyol;
wherein R⁴ and R⁵ are independently selected from the group consisting of H; optionally substituted alkyl, alkenyl, alkynyl, aryl, aralkyl, heterocyclyl, or heteroaryl; perfluoroalkyl; (CH₂)₁₋₁₀CO₂H; (CH₂)₁₋₁₀(CHOH)CO₂H; (CH₂CH₂O)ₓCH₃; CH₂(OCH₂CH₂)ₓOCH₃; CH(OH)CH₂OH; and C₂-C₆ polyol; and
wherein x is an integer ranging between 0 and about 100; and
wherein Zᵢ and Z₂ are optional substitutions independently selected from the group consisting of H; optionally substituted alkyl, alkenyl, alkynyl, aryl, aralkyl, heterocyclyl, or heteroaryl; C₂-C₆ polyol; C(═O)R³; C(═O)OR³; C(═O)NR⁴R⁵; OR³; O(C═O)R³; SR³; S(═O)R³; S(═O)₂R³; NR⁴R⁵; NR⁴C(═O)R⁴; NR⁴C(═O)NR⁴R⁵; (CH₂)₁₋₁₀CO₂H; (CH₂)₁₋₁₀(CHOH)CO₂H; CH₂(OCH₂CH₂)ₓOCH₃; CH₂(OCH₂CH₂)ₓOCH₃; CH(OH)CH₂OH; halogen; nitro; cyano; sulfonyl; and perfluoroalkyl; and
wherein n and m are integers independently ranging between 0 and 4.

9. The flow battery of claim 4, wherein the first redox-active material is an unbound form of the phenothiazine compound, the sulfur-oxidized variant thereof, or the salt thereof

10. The flow battery of claim 4, wherein the first redox-active material is a coordination compound comprising the phenothiazine compound, the sulfur-oxidized variant thereof, or the salt thereof as a ligand.

11. The flow battery of claim 4, wherein the first half-cell is a positive half-cell of the flow battery.

12. The flow battery of claim 11, wherein the second half cell is a negative half-cell of the flow battery, and the second redox-active material is a coordination compound.

13. The flow battery of claim 12, wherein the coordination compound comprises a titanium coordination compound.

14. The flow battery of claim 12, wherein the coordination compound has a formula of
D_{g}M(L¹)(L²)(L³);
wherein M is a transition metal; D is ammonium, tetraalkylammonium, an alkali metal ion, or any combination thereof g ranges between 0 and 6; and L¹, L² and L³ are ligands.

15. The flow battery of claim 14, wherein the transition metal is titanium.

16. The flow battery of claim 14, wherein at least one of L¹, L² and L³ is a catecholate ligand or a substituted catecholate ligand.

17. The flow battery of claim 11, wherein the first redox-active material is an unbound form of the phenothiazine compound, the sulfur-oxidized variant thereof, or the salt thereof

18. The flow battery of claim 1, wherein the first and second mobile ions are the same.
